(19) United States
(12) Patent Application Publication
(10) Pub. No.: US 2008/0081876 A1
(43) Pub. Date: Apr. 3, 2008

(54) Methods for making fiber reinforced polystyrene composites

(76) Inventors: Arnold Lustiger, Edison, NJ (US); Walter T. Matuszek, Easton, PA (US)

Correspondence Address: ExxonMobil Research and Engineering Company, P. O. Box 900, Annandale, NJ, 08801-0900, US

(21) Appl. No.: 11/542,519

(22) Filed: Oct. 3, 2006

(51) Int. Cl. C08F 8/00

(52) U.S. Cl. 525/177

(57) ABSTRACT

The present invention is directed generally processes for making fiber reinforced polystyrene compositions including from 5 to 50 wt % organic fiber, and from 0 to 60 wt % inorganic filler in a matrix of an atactic polystyrene based polymer. The process includes extrusion compounding the atactic polystyrene based polymer, the organic fiber, and the inorganic filler to form a fiber reinforced polystyrene resin, which is subsequently molded to form an article with a flexural modulus of at least 350,000 psi, and that exhibits ductility during instrumented impact testing. Extrusion compounding processes whereby the organic fiber is continuously fed to the extruder hopper by unwinding from one or more spools, and uniformly dispersing the fiber in the composites via twin screws having a combination of conveying and kneading elements are also disclosed. The extrusion compounding process and the molding process may also be fluidly coupled to provide an in-line compounding and molding process for producing the fiber reinforced polystyrene composites. Colored fiber may also be optionally incorporated into the process to yield articles with a cloth-like appearance. The processes for making fiber reinforced polystyrene compositions are suitable for making molded articles including, but not limited to, household appliances, automotive parts, and boat hulls.

### FIELD OF THE INVENTION

The present invention is directed generally to methods for making fiber reinforced polystyrene compositions having a flexural modulus of at least 350,000 psi and exhibiting ductility during instrumented impact testing. More particularly, the present invention relates to methods for consistently feeding fiber into a twin screw compounding process, and uniformly and randomly dispersing the fiber in the polystyrene and to an in-line compounding and molding process for making parts of fiber reinforced polystyrene composites.

### BACKGROUND OF THE INVENTION

Polystyrenes have limited use in engineering applications due to the tradeoff between toughness and stiffness. For example, atactic polystyrene is widely regarded as being relatively stiff, but suffers from poor toughness.

Several well known polystyrene compositions have been introduced which address toughness. For example, it is known to increase the toughness of atactic polystyrene by adding impact modifiers, such as rubber-like polymers. Rubber-like polymers include natural rubber, polybutadiene, polyisoprene, polyisobutylene, neoprene, polysulfide rubber, thiol rubber, acryl rubber, urethane rubber, silicone rubber, epichlorohydrin rubber, a styrene-butadiene block copolymer (SBR), a hydrogenated styrene-butadiene block copolymer (SEB, SBEC), a styrene-butadiene-styrene block copolymer (SBS), a hydrogenated styrene-butadiene-styrene block copolymer (SEBS), a styrene-isoprene block copolymer (SIR), a hydrogenated styrene-isoprene block copolymer (SEP), a styrene-isoprene-styrene copolymer (SIS), a hydrogenated styrene-isoprene-styrene block copolymer (SEPS), ethylene-propylene rubber (EPM), or ethylene-propylene-diene rubber (EPDM). Other examples also include core-shell type granular elastic substances such as butadiene-acrylonitrile-styrene core-shell rubber (ABS), methyl methacrylate-butadiene-styrene core-shell rubber (MBS), methyl methacrylate-butyl acrylate-styrene core-shell rubber (MAS), octyl acrylate-butadiene-styrene core-shell rubber (MABS), alkyl acrylate-butadiene-acrylonitrile-styrene core-shell rubber (AABS), butadiene-styrene core-shell rubber (SBR), or siloxane-containing core-shell rubber such as methyl methacrylate-butyl acrylate-siloxane core-shell rubber, and modified rubber thereof. However, while toughness is improved, the stiffness maybe considerably reduced using this approach. The rubber-like elastic polymers are incorporated into the polystryene in an amount of generally 60 wt. % or less with higher loading results in a greater decrease in stiffness.

Household appliances, boat hulls, and automotive parts often require a unique combination of toughness, stiffness and aesthetics. Many interior automotive parts also require a cloth-like appearance and feel. To create such a cloth-like look in polypropylene (PP) or thermoplastic olefin (TPO) materials, various fiber based additives are added to a base polymer product. Typically the base material is a light gray color and the fiber based additives are a darker gray or blue color to create the cloth-like effect. However, the presence of these fibers causes a significant decrease in impact properties. To counter balance the loss of impact resistance, typically plastomers or ethylene-propylene-diene rubber (EPDM) are added. However these modifiers also lower the stiffness (flexural modulus) of the product, and substantially increase the raw material cost.

Consistently feeding PET fibers into a compounding extruder is an issue encountered during the production of fiber reinforced polymer composites. Gravimetric or vibrational feeders are used in the metering and conveying of polymers, fillers and additives into the extrusion compounding process. These feeders are designed to convey materials at a constant rate using a single or twin screw by measuring the weight loss in the hopper of the feeder. These feeders are effective in conveying pellets or powder, but are not effective in conveying cut fiber. Cut fiber tends to bridge and entangle in these feeders resulting in an inconsistent feed rate to the compounding process. More particularly, at certain times, fiber gets hung up in the feeder and little is conveyed, while at other times, an overabundance of fiber is conveyed to the compounding extruder, which results in an inconsistent percentage of fiber incorporated into the fiber reinforced polymer composite.

Another issue encountered during the production of fiber reinforced polymer composites is adequately dispersing the PET fibers into the polymer matrix while still maintaining the advantageous mechanical properties imparted by the incorporation of the PET fibers. More particularly, extrusion compounding screw configuration may impact the dispersion of PET fibers within the polymer matrix, and extrusion compounding processing conditions may impact not only the mechanical properties of the matrix polymer, but also the mechanical properties of the PET fibers.

In the production of parts molded from fiber reinforced polymer composites, the compounding step to incorporate fiber, filler and other additives into the polymer matrix is separate from the process to injection mold a part from the fiber reinforced polymeric composite. This results in the need to ship, handle and store resin produced from the compounding process before it is used in a subsequent injection molding process. In addition, the fiber reinforced composite resin undergoes a second heat history when being melted during the subsequent injection molding process, which may negatively affect the properties of the resulting part because of the properties of the reinforcing fiber being impacted. In addition, properties may be negatively impacted by the second heat history because of the molecular weight of the polymer matrix resin being reduced due to thermal degradation. Furthermore, the decoupling of the compounding process and the injection molding process decreases the flexibility available to the molder for altering the properties of molded parts via changes to the formulation of the fiber reinforced polymer composite (i.e. by adding more or less fiber or more or less filler).

A need exists of an improved method for making fiber reinforced polystyrene composites, and in particular, consistently feeding organic fiber into the polystyrene based resin during the compounding process to achieve a uniform distribution of cut fiber to enhance the impact resistance and flexural modulus of parts molded from the composite resin. In addition, a need exists for an improved method for making fiber reinforced polystyrene composites, and in particular, a process that may be used to both incorporate fiber and filler into the polystyrene based resin as well as mold a part from the resulting blend without having to produce an intermediate resin, such that a part molded from the blend includes a uniform distribution of cut fiber which has only undergone one heat history in order to improve the properties of the molded parts.

### SUMMARY OF THE INVENTION

It has surprisingly been found that organic fiber may be fed into a twin screw compounding extruder by continuously unwinding fiber from one or more spools into the feed hopper of a compounding extruder, and then chopping the fiber into ¼ inch to 1 inch lengths by the extruder screw(s) to form a fiber reinforced polystyrene based composite. Pre-chopped fiber may also be fed into the compounding extruder. It has also been found that organic fiber (pre-chopped or continuously unwound and chopped by the extruder screw(s)) may be fed into a compounding extruder coupled to an injection molding machine to form a fiber reinforced polystyrene based composite articles.

According to the present disclosure, an advantageous process for making a fiber reinforced polystyrene article comprises: (a) at least 30 wt %, based on the total weight of the composition, atactic polystyrene based polymer; (b) from 5 to 50 wt %, based on the total weight of the composition, organic fiber; and (c) from 0 to 60 wt %, based on the total weight of the composition, inorganic filler; wherein said article molded from said composition has a flexural modulus of at least 350,000 psi and exhibits ductility during instrumented impact testing, wherein the process comprises: (a) extrusion compounding the composition to form an extrudate, and (b) molding said extrudate to form said article.

Another aspect of the present disclosure relates to an advantageous process for making fiber reinforced polystyrene composite resin comprising: feeding into a twin screw extruder hopper at least 35 wt % of an atactic polystyrene based resin, continuously feeding by unwinding from one or more spools into said twin screw extruder hopper from 10 wt % to 50 wt % of a polyester fiber, feeding into a twin screw extruder from 15 wt % to 45 wt % of talc, extruding said atactic polystyrene based resin, said polyester fiber, and said talc through said twin screw extruder to form a fiber reinforced polystyrene composite melt, cooling said fiber reinforced polystyrene composite melt to form a solid fiber reinforced polystyrene composite, and pelletizing said solid fiber reinforced polystyrene composite to form a fiber reinforced polystyrene composite resin.

Still another aspect of the present disclosure relates to an advantageous process for making a fiber reinforced polystyrene article comprising: (a) providing an in-line compounding and molding machine comprising an extrusion compounding machine fluidly coupled to a molding machine; (b) extrusion compounding in said extrusion compounding machine a composition comprising: (i) at least 30 wt %, based on the total weight of the composition, atactic polystyrene based polymer; (ii) from 5 to 50 wt %, based on the total weight of the composition, organic fiber; and (iii) from 0 to 60 wt %, based on the total weight of the composition, inorganic filler; to form a melt extrudate; (c) conveying said melt extrudate to said molding machine; and (d) molding said melt extrudate in said molding machine to form an article having a flexural modulus of at least 350,000 psi and exhibiting ductility during instrumented impact testing.

Still yet another aspect of the present disclosure relates to an advantageous process for making a fiber reinforced polystyrene article comprising: providing an in-line compounding and molding machine comprising a twin screw extruder fluidly coupled to an injection molder, feeding into said twin screw extruder hopper at least 30 wt % of an atactic polystyrene based resin, continuously feeding by unwinding from one or more spools into said twin screw extruder hopper from 5 wt % to 50 wt % of an organic fiber, feeding into said twin screw extruder from 0 wt % to 60 wt % of an inorganic filler, extruding said atactic polystyrene based resin, said organic fiber, and said inorganic filler through said twin screw extruder to form a fiber reinforced polystyrene melt, conveying said fiber reinforced polystyrene melt to said injection molder, and molding said fiber reinforced polystyrene melt to form a fiber reinforced polystyrene article.

These and other features and attributes of the disclosed methods for making polystyrene resin compositions of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts an exemplary schematic of the process for making fiber reinforced polystyrene composites of the present invention.

FIG. 2 depicts an exemplary schematic of a twin screw extruder with a downstream feed port for making fiber reinforced polystyrene composites of the present invention.

FIG. 3 depicts an exemplary schematic of a twin screw extruder screw configuration for making fiber reinforced polystyrene composites of the present invention.

FIG. 4 depicts an exemplary schematic of the process for making cloth-like fiber reinforced polystyrene composites of the present invention.

FIG. 5 depicts an exemplary schematic of the in-line compounding and molding process with an intermediate melt reservoir for making fiber reinforced polystyrene composites of the present invention.

FIG. 6 depicts an alternative exemplary schematic of the in-line compounding and molding process without an intermediate melt reservoir for making fiber reinforced polystyrene composites of the present invention.

FIG. 7 depicts an exemplary schematic of the in-line compounding and molding process with an intermediate melt reservoir for making cloth-like fiber reinforced polystyrene composites of the present invention.

FIG. 8 depicts an alternative exemplary schematic of the in-line compounding and molding process without an intermediate melt reservoir for making the cloth-like fiber reinforced polystyrene composites of the present invention.

### DETAILED DESCRIPTION OF THE INVENTION

The present invention relates to improved methods for making fiber reinforced polystyrene compositions for use in molding applications. The fiber reinforced polystyrene compositions of the present invention include a combination of an atactic polystyrene based polymer matrix with organic fiber and inorganic filler, which in combination advantageously yield articles molded from the compositions with a flexural modulus of at least 350,000 psi and ductility during instrumented impact testing (15 mph, −29° C., 25 lbs). In addition, fiber reinforced polystyrene compositions of the present invention do not splinter during instrumented impact testing, and may be optionally produced to yield a cloth-like look and feel. All numerical values within the detailed description and the claims herein are understood as modified by “about.”

In one embodiment of the present invention, the organic reinforcing fiber is fed continuously into the feed hopper of a twin screw or other type of compounding extruder. In another embodiment of the present invention, organic reinforcing fiber is fed not only continuously into the feed hopper of the twin screw or other compounding extruder, but also the compounding extruder is coupled with a molding process to avoid making intermediate fiber reinforced polystyrene resin. In other embodiments, colorant fibers are further added to the processes to result in cloth-like fiber reinforced polystyrene composites without negatively affecting impact properties.

The fiber reinforced polystyrene compositions of the present invention simultaneously have desirable stiffness, as measured by having a flexural modulus of at least 350,000 psi, and toughness, as measured by exhibiting ductility during instrumented impact testing. In a particular embodiment, the compositions have a flexural modulus of at least 799,000 psi, or at least 1,540,000. It is also believed that having a weak interface between the polystyrene matrix and the fiber contributes to fiber pullout; and, therefore, may enhance toughness. Thus, there is no need to add modified polystyrenes to enhance bonding between the fiber and the polystyrene matrix, although the use of modified polystyrene may be advantageous to enhance the bonding between a filler, such as talc or wollastonite, and the matrix. In addition, in one embodiment, there is no need to add lubricant to weaken the interface between the polystyrene and the reinforcing fiber to further enhance fiber pullout. Some embodiments also display no splintering during instrumented dart impact testing, which yield a further advantage of not subjecting a person in close proximity to the impact to potentially harmful splintered fragments. This characteristic is advantageous in automotive applications.

Compositions of the present invention generally include at least 30 wt %, based on the total weight of the composition, of polystyrene as the matrix resin. In a particular embodiment, the polystyrene is present in an amount of at least 30 wt %, or at least 35 wt %, or at least 40 wt %, or at least 50 wt %, or at least 60 wt %, or at least 70 wt %, or in an amount within the range having a lower limit of 30 wt %, and an upper limit of 80 wt %, based on the total weight of the composition.

The polystyrene used as the matrix resin of the present invention is a styrene based polymer having an atactic structure and is therefore amorphous. The term styrene based polymer refers to any solid homopolymer or copolymer of styrene with an atactic structure having a softening point not less than 70° C. The styrene polymers having an atactic steric structure that may be used in the present invention are polymers which can be produced through solvent polymerization, bulk polymerization, suspension polymerization, or bulk-suspension polymerization, and comprise: a polymer formed of one or more aromatic vinyl compounds represented by the following formula (1) below; a copolymer of one or more aromatic vinyl compounds and one or more other vinyl monomers which are copolymerizable with the aromatic vinyl compounds; a hydrogenated polymer thereof; and a mixture thereof.

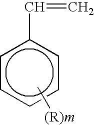

wherein R represents a hydrogen atom, a halogen atom, or a substituent containing one or more atoms selected from among a carbon atom, an oxygen atom, a nitrogen atom, a sulfur atom, a phosphorus atom, a selenium atom, a silicon atom, and a tin atom; m is an integer between 1 and 3 inclusive, and when m is 2 or 3, a plurality of R's may be identical to or different from one another.

Examples of aromatic vinyl compounds which may be used include styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, and ethoxystyrene. These may be used singly or in combination of two or more species. Of these, styrene, p-methylstyrene, m-methylstyrene, p-tertiary butylstyrene, p-chlorostyrene, m-chlorostyrene, and p-fluorostyrene are particularly preferred.

Examples of other copolymerizable vinyl monomers include vinylcyan compounds such as acrylonitrile, or methacrylonitrile; acrylate esters such as methyl acrylate, ethyl acrylate, propyl acrylate, butyl acrylate, amyl acrylate, hexyl acrylate, octyl acrylate, 2-ethylhexyl acrylate, cyclohexyl acrylate, dodecyl acrylate, octadecyl acrylate, phenyl acrylate, or benzyl acrylate; methacrylate esters such as methyl methacrylate, ethyl methacrylate, butyl methacrylate, amyl methacrylate, hexyl methacrylate, octyl methacrylate, 2-ethylhexyl methacrylate, cyclohexyl methacrylate, dodecyl methacrylate, octadecyl methacrylate, phenyl methacrylate, or benzyl methacrylate; maleimide compounds such as maleimide, N-methylmaleimide, N-ethylmaleimide, N-butylmaleimide, N-laurylmaleimide, N-cyclohexylmaleimide, N-phenylmaleimide, or N-(p-bromophenyl)maleimide.

Other copolymerizable vinyl monomers include rubber-like polymers. Examples of copolymerizable rubber-like polymers include diene rubber such as polybutadiene, a styrene-butadiene copolymer, an acrylonitrile-butadiene copolymer, or polyisoprene; non-diene rubber such as an ethylene-α-olefin copolymer, an ethylene-α-olefin-polyene copolymer, or poly(acrylate ester); a styrene-butadiene block copolymer; a hydrogenated styrene-butadiene block copolymer; an ethylene-propylene elastomer; a styrene-graft-ethylene-propylene elastomer; an ethylenic ionomer resin; and a hydrogenated styrene-isoprene copolymer.

No particular limitation is imposed on the molecular weight of the atactic polystyrene. The weight-average molecular weight of the atactic polystyrene is generally 10,000 or more, and more particularly from 50,000 to 2,000,000. In a particular embodiment, the weight-average molecular weight of the atactic polystyrene is greater than or equal to 500,000, greater than or equal to 750,000, greater than or equal to 1,000,000, greater than or equal to 1,250,000, greater than or equal to 1,500,000 and still more particularly greater than 1,750,000. When the weight-average molecular weight is less than 10,000, the resultant molded articles disadvantageously have poor thermal and mechanical properties. Also, no particular limitation is imposed on the molecular weight distribution of the atactic polystyrene based polymer, and a wide range thereof may be used.

The polystyrene of the matrix resin may have a melt flow rate of from 1 to 100 g/10 min. In a particular embodiment, the melt flow rate of the polystyrene matrix resin is greater than or equal to 10 g/10 min, greater than or equal to 15 g/10 min, greater than or equal to 20 g/10 min, greater than or equal to 25 g/min, and still more particularly greater than 30 g/10 min. The higher melt flow rate permits for improvements in processability, throughput rates, and higher loading levels of organic fiber and inorganic filler without negatively impacting flexural modulus and impact resistance.

The atactic polystyrene based polymer may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polystyrene matrix is generally from 0.1 wt %, or 1.0 wt %, or 2.5 wt %, or 7.5 wt %, or 10 wt %, based on the total weight of the matrix. Diffusion of additive(s) during processing may cause a portion of the additive(s) to be present in the fiber.

The polystyrene composites of the present invention do not require the blending of a rubber-like elastic polymer substance in order to improve the impact resistance. In order to improve the impact resistance, organic fibers, also referred to as reinforcing fibers, are incorporated into the atactic polystyrene based polymer matrix.

Compositions of the present invention generally include at least 5 wt %, based on the total weight of the composition, of an organic fiber. In a particular embodiment, the fiber is present in an amount of at least 7.5 wt %, or at least 10 wt %, or at least 12.5 wt %, or at least 15 wt %. More particularly, the organic fiber is present in an amount within the range having a lower limit of 5 wt %, or 7.5 wt %, or 10 wt %, or 12.5 wt %, and an upper limit of 15 wt %, or 20 wt %, or 30 wt %, or 50 wt %, based on the total weight of the composition.

The polymer used as the fiber is not particularly restricted and is generally chosen from polyalkylene terephthalates, polyalkylene naphthalates, polyamides, polyolefins, polyacrylonitrile, and combinations thereof. In a particular embodiment, the fiber comprises a polymer chosen from polyethylene terephthalate (PET), polybutylene terephthalate, polyamide and acrylic. In another particular embodiment, the organic fiber comprises PET. In one particular embodiment, at a PET fiber loading of 15 wt %, the polystyrene fiber composite exhibited a flexural modulus of 1,540,000 psi and no splintering during instrumented impact testing (15 mph, −29° C., 25 lbs). In another particular embodiment, at a PET fiber loading of 12.5 wt %, the polystyrene fiber composite exhibited a flexural modulus of 799,000 psi and no splintering during instrumented impact testing (15 mph, −29° C., 25 lbs).

In one embodiment, the reinforcing fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the reinforcing fibers of the present invention are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The reinforcing fiber may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment.

The reinforcing fiber used to make the compositions of the present invention is not limited by any particular fiber form. For example, the fiber can be in the form of continuous filament yarn, partially oriented yarn, or staple fiber. In another embodiment, the fiber may be a continuous multifilament fiber or a continuous monofilament fiber.

In another embodiment of the present invention, the fiber reinforced polystyrene compositions further include from 0.01 to 0.2 wt %, or more particularly from 0.05 to 0.1 wt % lubricant, based on the total weight of the composition. Suitable lubricants include, but are not limited to, silicon oil, silicon gum, fatty amide, paraffin oil, paraffin wax, ester oil, and combinations thereof. Lubricant incorporation may assist with the pull-out of organic fiber from the atactic styrene based matrix polymer to further improve impact resistance.

In another exemplary embodiment of the present invention, the fiber reinforced polystyrene composition may be made cloth-like in terms of appearance, feel, or a combination thereof. Cloth-like appearance or look is defined as having a uniform short fiber type of surface appearance. Cloth-like feel is defined as having a textured surface or fabric type feel. The incorporation of the colorant fiber into the fiber reinforced polystyrene composition results in a cloth-like appearance. When the fiber reinforced polystyrene composition is processed through a mold with a textured surface, a cloth-like feel is also imparted to the surface of the resulting molded part.

Cloth-like fiber reinforced polystyrene compositions of the present invention generally include from 0.1 to 2.5 wt %, or from 0.5 to 1.5 wt %, based on the total weight of the composition, of a colorant fiber. In one particular embodiment, the colorant fiber is present at less than 1.0 wt %, based on the total weight of the composition.

The colorant fiber type is not particularly restricted and is generally chosen from cellulosic fiber, acrylic fiber, nylon fiber or polyester type fiber. Polyester type fibers include, but are not limited to, polyethylene terephthalate, polybutylene terephthalate, and polyethylene naphthalate. Polyamide type fibers include, but are not limited to, nylon 6, nylon 6,6, nylon 4,6 and nylon 6,12. In a particular embodiment, the colorant fiber is cellulosic fiber, also commonly referred to as rayon. In another particular embodiment, the colorant fiber is a nylon type fiber.

The colorant fiber used to make the compositions of the present invention is not limited by any particular fiber form prior to being chopped for incorporation into the fiber reinforced polystyrene composition. For example, the colorant fiber can be in the form of continuous filament yarn, partially oriented yarn, or staple fiber. In another embodiment, the colorant fiber may be a continuous multifilament fiber or a continuous monofilament fiber.

The length and diameter of the colorant fiber may be varied to alter the cloth-like appearance in the molded article. The length and diameter of the colorant fiber of the present invention is not particularly restricted. In a particular embodiment, the fibers have a length of less than ¼ inch, or more particularly a length of between 1/32 to ⅛ inch. In another particular embodiment, the diameter of the colorant fibers is within the range having a lower limit of 10 μm and an upper limit of 100 μm.

The colorant fiber is colored with a coloring agent, which comprises either inorganic pigments, organic dyes or a combination thereof. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Exemplary pigments and dyes incorporated into the colorant fiber include, but are not limited to, phthalocyanine, azo, condensed azo, azo lake, anthraquinone, perylene/perinone, indigo/thioindigo, isoindolinone, azomethineazo, dioxazine, quinacridone, aniline black, triphenylmethane, carbon black, titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatments in a manner known per se in the art. Depending on the material to be colored, the coloring agent can be added with one or more of various additives such as organic solvents, resins, flame retardants, antioxidants, ultraviolet absorbers, plasticizers and surfactants.

The base fiber reinforced polystyrene composite material that the colorant fiber is incorporated into may also be colored using the inorganic pigments, organic dyes or combinations thereof. Exemplary pigments and dyes for the base fiber reinforced polystyrene composite material may be of the same types as indicated in the preceding paragraph for the colorant fiber. Typically the base fiber reinforced polystyrene composite material is made of a different color or a different shade of color than the colorant fiber, such as to create a cloth-like appearance upon uniformly dispersing the short colorant fibers in the colored base fiber reinforced polystyrene composite material. In one particular exemplary embodiment, the base fiber reinforced polystyrene composite material is light grey in color and the colorant fiber is dark grey or blue in color to create a cloth-like look from the addition of the short colorant fiber uniformly dispersed through the base fiber reinforced polystyrene composite material.

The colorant fiber in the form of chopped fiber may be incorporated directly into the base fiber reinforced polystyrene composite material via the twin screw extrusion compounding process, or may be incorporated as part of a masterbatch resin to further facilitate the dispersion of the colorant fiber within the fiber reinforced polystyrene composite base material. When the colorant fiber is incorporated as part of a masterbatch resins, exemplary carrier resins include, but are not limited to, atactic polystyrene, syndiotactic polystyrene, impact modified polystyrene, copolymers of polystyrene, polypropylene homopolymer, ethylene-propylene copolymer, ethylene-propylene-butene-1 terpolymer, propylene-butene-1 copolymer, low density polyethylene, high density polyethylene, and linear low density polyethylene. In one exemplary embodiment, the colorant fiber is incorporated into the carrier resin at less than 25 wt %. The colorant fiber masterbatch is then incorporated into the fiber reinforced polystyrene composite base material at a loading of from 1 wt % to 10 wt %, and more particularly from 2 to 6 wt %. In one embodiment, the colorant fiber masterbatch is added at 4 wt % based on the total weight of the composition. In another exemplary embodiment, a masterbatch of either black rayon or black nylon type fibers in linear low density polyethylene carrier resin is incorporated at a loading of 4 wt % in the fiber reinforced polystyrene composite base material.

The colorant fiber or colorant fiber masterbatch may be fed to the extrusion compounding process with a gravimetric feeder at either the feed hopper or at a downstream feed port in the barrel of the extrusion compounder. Kneading and mixing elements are incorporated into the extruder screw design downstream of the colorant fiber or colorant fiber masterbatch injection point, such as to uniformly disperse the colorant fiber within the cloth-like fiber reinforced polystyrene composite material.

Compositions of the present invention optionally include inorganic filler in an amount of at least 5 wt %, or at least 10 wt %, or at least 15 wt %, or at least 20 wt %, based on the total weight of the composition. The inorganic filler is included at an upper limit of 40 wt %, or 50 wt %, or 60 wt %, based on the total weight of the composition. In a particular embodiment, the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from 1 to 100 microns.

In one particular embodiment, at a talc loading of up to about 40 wt %, the polystyrene fiber composite exhibited a flexural modulus of 1,540,000 psi and no splintering during instrumented impact testing (15 mph, −29° C., 25 lbs). In another particular embodiment, at talc loading of 20 wt %, the polystyrene fiber composite exhibited a flexural modulus of 799,000 psi and no splintering during instrumented impact testing (15 mph, −29° C., 25 lbs). In addition, wollastonite loadings of from 5 wt % to 60 wt % in the polystyrene fiber composite yield an outstanding combination of impact resistance and stiffness.

In one exemplary embodiment, a fiber reinforced polystyrene composition including an atactic polystyrene based resin, 5 to 50 wt % of polyester fiber, and 0 to 60 wt % of talc yields a flexural modulus of at least 350,000 and did not shatter during instrumented impact testing at −29 degrees centigrade, tested at 25 pounds and 15 miles per hour. In another particular embodiment, a fiber reinforced polystyrene composition including an atactic polystyrene homopolymer with a melt flow rate of 20, 12 to 15 wt % of polyester fiber, and 20 to 41 wt % of talc displayed a flexural modulus of at least 799,000 and did not shatter during instrumented impact testing at −29 degrees centigrade, tested at 25 pounds and 15 miles per hour. This combination of stiffness and toughness is difficult to achieve in a polymeric based material.

The fiber reinforced polystyrene based composites of the present invention allow for an approximately doubling of the stiffness of the composites for a given level of inorganic filler and organic fiber in comparison to fiber reinforced polypropylene based composites. As a result, fiber reinforced polystyrene composites of the present invention allow for a reduction in the inorganic filler loading while still maintaining stiffness in comparison to fiber reinforced polypropylene composites. A lower filler loading improves part surface quality and lowers the density of the parts reduced. Correspondingly, this permits fiber reinforced polystyrene composites to be used in exterior automotive applications where paint appearance is important. High filler loadings needed for stiffness in fiber reinforced polypropylene composites have a deleterious effect on part surface smoothness, thereby limiting the use of these materials in exterior automotive applications where paint appearance is important. This limitation does not exist for fiber reinforced polystyrene composites of the present invention.

In another embodiment, the present invention provides for parts molded from such fiber reinforced polystyrene compositions. Articles made from the fiber-reinforced polystyrene compositions described herein include, but are not limited to, automotive parts, household appliances, and boat hulls. Automotive parts include both interior and exterior automobile parts. Cloth-like fiber reinforced polystyrene articles are particularly suitable for interior automotive parts because of the unique combination of toughness, stiffness and aesthetics. More particularly, the non-splintering nature of the failure mode during instrumented impact testing, and the cloth-like look make the cloth-like fiber reinforced polystyrene composites of the present invention particularly suited for interior automotive parts, and even more particularly suited for interior trim cover panels. Exemplary, but not limiting, interior trim cover panels include steering wheel covers, head liner panels, dashboard panels, interior door trim panels, pillar trim cover panels, and under-dashboard panels. Pillar trim cover panels include a front pillar trim cover panel, a center pillar trim cover panel, and a quarter pillar trim cover panel. Other interior automotive parts include package trays, and seat backs. Articles made from the polystyrene compositions described herein are also suitable for exterior automotive parts, including, but not limited to, bumpers, aesthetic trim parts, body panels, under body parts, under hood parts, door cores, and other structural parts of the automobile.

Articles of the present invention are made by forming a fiber-reinforced polystyrene resin composition and then molding the resin composition to form the article. Injection molding is one exemplary method for molding parts from the fiber-reinforced polystyrene resin composition. The invention is not limited by any particular method for forming the resin composition. For example, the resin composition may be formed by contacting polystyrene, organic fiber, and optional inorganic filler in any of the well known processes of pultrusion or extrusion compounding. In a particular embodiment, the resin composition is formed in an extrusion compounding process (single screw or twin screw compounder). In a particular aspect of this embodiment, the organic fibers are cut (to create chopped fiber) prior to being metered in the extruder hopper. In another particular aspect of this embodiment, the organic fibers are fed directly from one or more spools into the extruder hopper of the extrusion compounding process. In yet another particular aspect of this embodiment, the cut organic fibers are metered into the extrusion compounding process downstream of the extruder hopper.

The fiber reinforced polystyrene composites of the present invention include, but are not limited to, one or more of the following advantages: an advantageous combination of toughness, stiffness, and aesthetics, improved instrumented impact resistance, improved flexural modulus, improved splinter or shatter resistance during instrumented impact testing, fiber pull out during instrumented impact testing without the need for lubricant additives, ductile (non-splintering) failure mode during instrumented impact testing as opposed to brittle (splintering), a higher heat distortion temperature compared to rubber modified polystyrene, improved part surface appearance from lower inorganic filler loadings, lower part density from lower inorganic filler loadings, a lower flow and cross flow coefficient of linear thermal expansion compared to rubber modified polystyrene, the ability to continuously and accurately feed organic reinforcing fiber into a compounding extruder, reduced production costs and reduced raw material costs, improved part surface appearance, the ability to produce polystyrene fiber composites exhibiting a cloth-like look and/or feel, uniform dispersion of the organic reinforcing fiber and colorant fiber in the composite pellets, and retention of impact resistance, ductile failure mode and stiffness after the incorporation of colorant with colorant fiber.

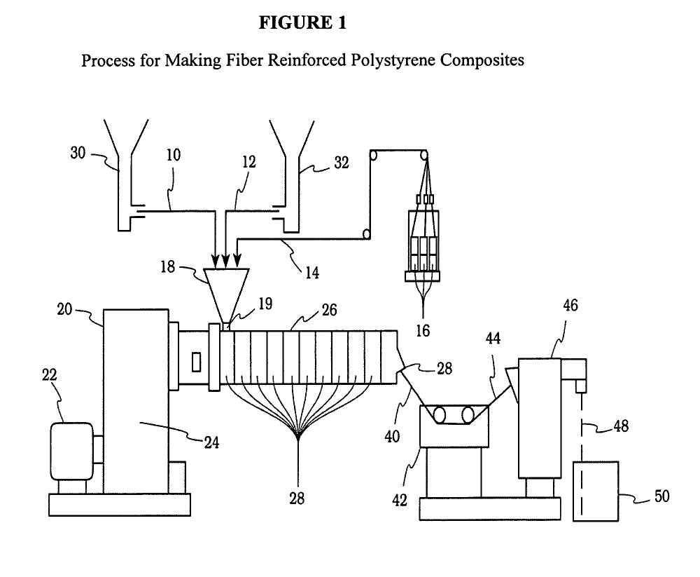

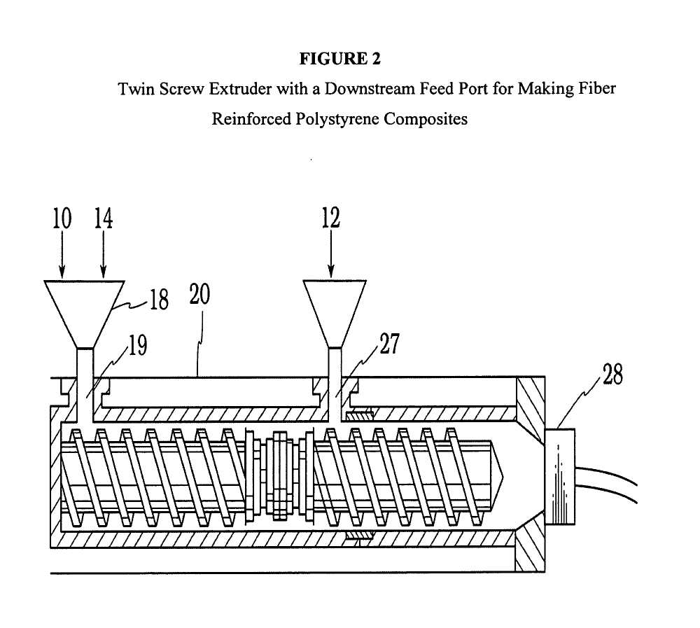

In one exemplary embodiment, organic reinforcing fiber is continuously feed from spools into the feed hopper of a compounding extruder as depicted in FIG. 1. Atactic polystyrene based resin 10, inorganic filler 12, and organic fiber 14 continuously unwound from one or more spools 16 are fed into the extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the atactic polystyrene based resin 10 and the inorganic filler 12 prior to entering the feed throat 19 of the twin screw compounding extruder 20. In an alternative embodiment, as depicted in FIG. 2, the inorganic filler 12 may be fed to the compounding extruder 20 at a downstream feed port 27 in the extruder barrel 26 positioned downstream of the extruder hopper 18 while the atactic polystyrene based resin 10 and the organic fiber 14 are still metered into the extruder hopper 18.

Referring to FIG. 1, the atactic polystyrene based resin 10 is metered to the extruder hopper 18 via a feed system 30 for accurately controlling the feed rate. Similarly, the inorganic filler 12 is metered to the extruder hopper 18 via a feed system 32 for accurately controlling the feed rate. The feed systems 30, 32 may be, but are not limited to, gravimetric feed systems or volumetric feed systems. Gravimetric feed systems may more accurately control the weight percentage of atactic polystyrene based resin 10 and inorganic filler 12 being fed to the extruder hopper 18. The feed rate of organic fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic fiber 14 is fed to the twin screw compounding screw 20. The rate at which organic fiber 14 is fed to the extruder hopper also increases with the greater the number of filaments within the organic fiber 14 being unwound from a single fiber spool 16, the greater filament thickness, the greater the number fiber spools 16 being unwound simultaneously, and the rotations per minute of the extruder.

Referring again to FIG. 1, the twin screw compounding extruder 20 includes a drive motor 22, a gear box 24, an extruder barrel 26 for holding two screws (not shown), and a strand die 28. The extruder barrel 26 is segmented into a number of heated temperature controlled zones 28. The extruder barrel 26 includes a total of ten temperature control zones 28. The two screws within the extruder barrel 26 of the twin screw compounding extruder 20 may be intermeshing or non-intermeshing, and may rotate in the same direction (co-rotating) or rotate in opposite directions (counter-rotating). From a processing perspective, the melt temperature should be maintained above the softening point temperature of the atactic polystyrene based resin 10, and below the melting temperature of the organic fiber 14, such that the mechanical properties imparted by the organic fiber will be maintained when mixed into the atactic polystyrene based resin 10. In one exemplary embodiment, the barrel temperature of the extruder zones of a single screw compounding extruder did not exceed 175° C. when extruding atactic polystyrene resin, PET fiber and talc, which yielded a melt temperature above the softening point of the polystyrene, but still below the melting point of the PET fiber. In another exemplary embodiment, the barrel temperatures of the compounding extruder are set at 185° C. or lower. In yet another exemplary embodiment, the barrel temperatures of the extruder zones are set at 210° C. or lower.

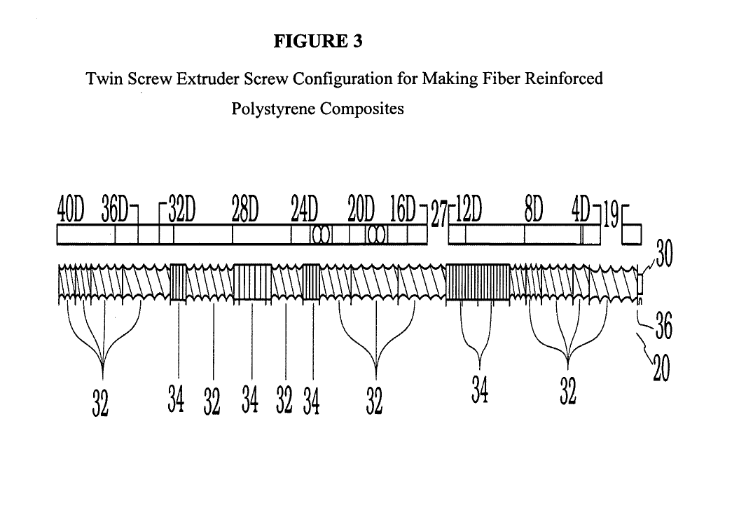

An exemplary schematic of a twin screw compounding extruder 20 screw configuration for making fiber reinforced polystyrene composites is depicted in FIG. 3. The feed throat 19 allows for the introduction of atactic polystyrene based resin, organic fiber, and inorganic filler into a feed zone of the twin screw compounding extruder 20. The inorganic filler may be optionally fed to the extruder 20 at the downstream feed port 27. The twin screws 30 include an arrangement of interconnected screw sections, including conveying elements 32 and kneading elements 34. The kneading elements 34 function to soften the atactic polystyrene based resin, cut the organic fiber lengthwise, and mix the atactic polystyrene, chopped organic fiber and inorganic filler to form a uniform blend. More particularly, the kneading elements function to break up the organic fiber into about ⅛ inch to about 1 inch fiber lengths. A series of interconnected kneading elements 34 is also referred to as a kneading block. U.S. Pat. No. 4,824,256 to Haring et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, soften the atactic polystyrene based resin, and convey the melt mixture of atactic polystyrene based polymer, inorganic filler and organic fiber downstream toward the strand die 28 (refer to FIG. 1) at a positive pressure.

The position of each of the screw sections as expressed in the number of diameters (D) from the start 36 of the extruder screws 30 is also depicted in FIG. 3. The extruder screws in FIG. 3 have a length to diameter ratio of 40/1, and at a position 32D from the start 36 of screws 30, there is positioned a kneading element 34. The particular arrangement of kneading and conveying sections is not limited to that as depicted in FIG. 3, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

Referring once again to FIG. 1, the uniformly mixed fiber reinforced polystyrene composite melt comprising atactic polystyrene based polymer 10, inorganic filler 12, and organic fiber 14 is metered by the extruder screws to a strand die 28 for forming one or more continuous strands 40 of fiber reinforced polystyrene composite melt. The one or more continuous strands 40 are then passed into water bath 42 for cooling them below the melting point of the fiber reinforced polystyrene composite melt to form a solid fiber reinforced polystyrene composite strands 44. The water bath 42 is typically cooled and controlled to a constant temperature much below the softening point of the polystyrene based polymer. The solid fiber reinforced polystyrene composite strands 44 are then passed into a pelletizer or pelletizing unit 46 to cut them into fiber reinforced polystyrene composite resin 48 measuring from about ¼ inch to about 1 inch in length. The fiber reinforced polystyrene composite resin 48 may then be accumulated in boxes 50, barrels, or alternatively conveyed to silos for storage.

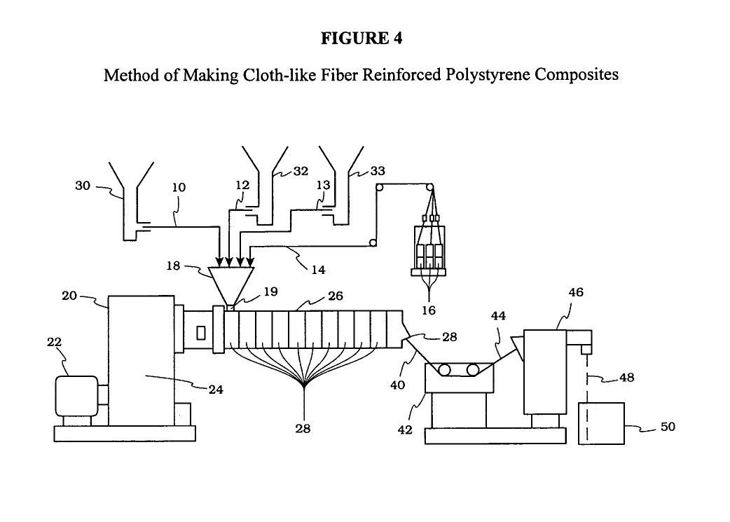

In another exemplary embodiment, the method for making fiber reinforced polystyrene composites further provides for making cloth-like compositions. FIG. 4 depicts an exemplary schematic of the process for making cloth-like fiber reinforced polystyrene composites of the instant invention. Atactic polystyrene based resin 10, inorganic filler 12, colorant fiber 13, and organic reinforcing fiber 14 continuously unwound from one or more spools 16 are fed into the extruder hopper 18 of a twin screw compounding extruder 20. Colorant fiber 13 is may be in the form of a masterbatch resin. The extruder hopper 18 is positioned above the feed throat 19 of the twin screw compounding extruder 20. The extruder hopper 18 may alternatively be provided with an auger (not shown) for mixing the atactic polystyrene based resin 10 and the inorganic filler 12 prior to entering the feed throat 19 of the twin screw compounding extruder 20. In an alternative embodiment, as depicted in FIG. 2, the inorganic filler 12 and/or the colorant fiber (not shown) may be fed to the compounding extruder 20 at a downstream feed port 27 in the extruder barrel 26 positioned downstream of the extruder hopper 18 while the atactic polystyrene based resin 10 and the organic reinforcing fiber 14 are still metered into the extruder hopper 18.

Referring to FIG. 4, the colorant fiber 13 is metered to the extruder hopper 18 via feed system 33 for accurately controlling the feed rate. The feed system 33 may be, but is not limited to, gravimetric feed system or volumetric feed systems with gravimetric feed systems yielding improved accuracy for controlling the weight percentage of colorant fiber 13 being fed to the extruder hopper 18. The uniformly mixed fiber reinforced polystyrene composite melt comprising atactic polystyrene based polymer 10, inorganic filler 12, colorant fiber 13, and organic reinforcing fiber 14 is metered by the extruder screws to a strand die 28 for forming one or more continuous strands 40 of colored fiber reinforced polystyrene composite melt. The one or more continuous strands 40 are then passed into water bath 42 for cooling them below the softening point of the colored fiber reinforced polystyrene composite melt to form a solid colored fiber reinforced polystyrene composite strands 44. The water bath 42 is typically cooled and controlled to a constant temperature much below the softening point of the polystyrene based polymer. The solid colored fiber reinforced polystyrene composite strands 44 are then passed into a pelletizer or pelletizing unit 46 to cut them into colored fiber reinforced polystyrene composite resin 48 measuring from about ¼ inch to about 1 inch in length. The colored fiber reinforced polystyrene composite resin 48 may then be accumulated in boxes 50, barrels, or alternatively conveyed to silos for storage.

In still yet another exemplary embodiment of the method for making fiber reinforced polystyrene composites, organic reinforcing fiber is continuously feed from spools into the feed hopper of an extrusion compounder and the extruder compounder is directly coupled to a molding machine to form an article or part via a combined in-line compounding and molding process. The combination or coupling of the compounding and molding steps into a single process is referred to as in-line compounding and molding process. The in-line compounding and molding process for making fiber reinforced polystyrene compositions of the present invention combines the beneficial aspects of the compounding of polystyrene resin, organic fiber and inorganic filler through a compounding process with the beneficial aspects of molding the compounded melt to form a fiber reinforced polystyrene article or part. Exemplary, but not limiting, compounding processes include twin screw extrusion, and single screw extrusion. Twin screw extrusion may more effectively disperse high additive loadings into a polymeric melt in comparison to single screw extrusion. Exemplary, but not limiting, molding processes include injection molding, blow molding, rotational molding, thermoforming, compression molding, and compression/injection molding. Injection molding is advantageous because of its ability to produce a wide range of plastic parts and articles. U.S. Pat. Nos. 6,071,462 and 6,854,968 are directed to combined compounder-type injection molding machines and are both herein incorporated by reference in their entirety.

The in-line compounding and molding process of the present invention may eliminate the need of a molder having to stock various % levels of PET fiber in polystyrene and from buying several different kinds of PP/PS with the correct fiber levels needed. It may also eliminate issues with storage, cost, and heat history associated with separate compounding and molding processes. In particular, if a molder would need various % levels of PET fiber in polystyrene, they would need to buy several different kinds of PP/PS with the correct fiber levels. This would take up a lot of storage space. Another beneficial aspect of the pre-compounding of the PS and PET fiber may be a reduction in the cost of the final product. Compounding costs of between $0.06 to $0.50 per pound may be eliminated with the in-line compounding and molding process of the present invention.

Another benefit of the in-line compounding and molding process for making fiber reinforced polystyrene composites of the present invention is that the number of heat histories of the material is reduced, which in turn improves the physical properties of the finished product. PET fiber is heat set at approximately 420 deg. F. Each time the polymer is melted in the presence of the fiber, there is some possibility of the fiber losing its mechanical integrity. If the fiber is heated above the heat set temperature at which the fiber is formed, it may decrease the impact improvement properties provided by the PET fiber to the polystyrene. Using the in-line compounding and molding process of the present invention, materials comprising reinforced polystyrene compositions may be compounded and molded all in one step. The polymer, fiber and talc filler may be introduced into a compounding extruder attached directly to an injection or compression molder. Instead of creating pellets of compounded material in a separate compounding process, which are later molded, the molten compound is conveyed directly to the mold from the compounding process.

In one exemplary embodiment of the in-line compounding and molding process for making fiber reinforced polystyrene composites of the present invention, between the compounding process and the molding process may be positioned a melt reservoir for holding surge melt from the continuous compounding process before it enters into the discontinuous molding process. In another exemplary embodiment of the in-line compounding and molding process for making fiber reinforced polystyrene composites of the present invention, between the compounding process and the molding process is a flow channel without a melt reservoir that leads to two or more molding units.

In another exemplary embodiment, an in-line compounding and molding machine may blend in the organic fiber into the polystyrene melt stream. The machine has a special extruded/plunger system that can soften the atactic polystyrene resin, feed in the organic fiber, and any other reinforcement or additives needed in the product. The plunger or injection unit then acts as a standard injection molding machine that injects the material into the mold. Fibers may also be fed into the extruder from spools or from a feeder that feeds chopped fibers of the desired length. This permits the molder to put in as much or little fiber as desired. Also the PET fiber is only subjected to one heat history reducing the likelihood of negatively impacting the fiber properties.

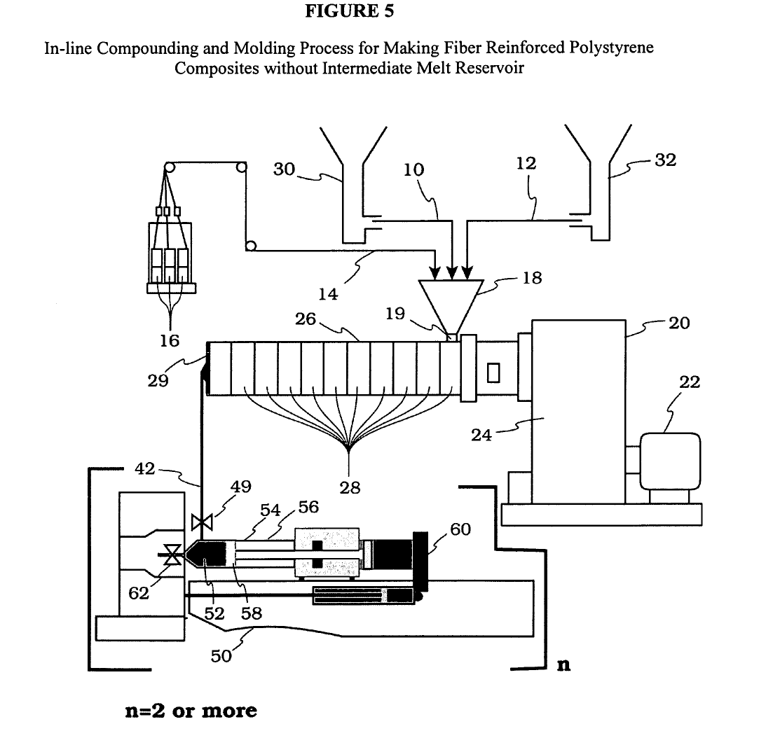

FIG. 5 depicts an exemplary schematic of the in-line process for making fiber reinforced polystyrene composites of the instant invention. Atactic polystyrene based resin 10, inorganic filler 12, and organic fiber 14 continuously unwound from one or more spools 16 are fed into an extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the atactic polystyrene based resin 10 and the inorganic filler 12 prior to entering the feed throat 19 of the twin screw compounding extruder 20. In an alternative embodiment, as depicted in FIG. 2, the inorganic filler 12 may be fed to the twin screw compounding extruder 20 at a downstream feed port 27 in the extruder barrel 26 positioned downstream of the extruder hopper 18 while the atactic polystyrene based resin 10 and the organic fiber 14 are still metered into the extruder hopper 18.

Referring to FIG. 5, the atactic polystyrene based resin 10 is metered to the extruder hopper 18 via a feed system 30 for accurately controlling the feed rate. Similarly, the inorganic filler 12 is metered to the extruder hopper 18 via a feed system 32 for accurately controlling the feed rate. The feed systems 30, 32 may be, but are not limited to, gravimetric feed systems or volumetric feed systems. Gravimetric feed systems more accurately control the weight percentage of atactic polystyrene based resin 10 and inorganic filler 12 being fed to the extruder hopper 18. The feed rate of organic fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic fiber 14 is fed to the twin screw compounding screw 20. The rate at which organic fiber 14 is fed to the extruder hopper also increases with the greater the number of filaments within the organic fiber 14 being unwound from a single fiber spool 16, the greater filament thickness, the greater the number fiber spools 16 being unwound simultaneously, and the rotations per minute of the extruder.

Referring again to FIG. 5, the twin screw compounding extruder 20 includes a drive motor 22, a gear box 24, and an extruder barrel 26 for holding two screws (not shown). The extruder barrel 26 is segmented into a number of heated temperature controlled zones 28. The two screws within the extruder barrel 26 of the twin screw compounding extruder 20 may be intermeshing or non-intermeshing, and may rotate in the same direction (co-rotating) or rotate in opposite directions (counter-rotating). From a processing perspective, the melt temperature should be maintained above the softening point temperature of the atactic polystyrene based resin 10, and far below the melting temperature of the organic fiber 14, such that the mechanical properties imparted by the organic fiber will be maintained when mixed into the atactic polystyrene based resin 10. An exemplary schematic of a twin screw compounding extruder 20 screw configuration for use in the in-line compounding and molding process of the present invention is the same as depicted in FIG. 3.

Referring once again to FIG. 5, the uniformly mixed fiber reinforced polystyrene composite melt comprising atactic polystyrene based polymer 10, inorganic filler 12, and organic fiber 14 is metered by the extruder screws (not shown) to the discharge end of the extruder 29 to which is coupled or connected to a heated and temperature controlled melt pipe 42 which leads to a shut-off/purge valve 44. The fiber reinforced polystyrene composite melt then leads to an intermediate melt reservoir 46 for temporary storage prior to being conveyed to another heated and temperature controlled melt pipe 48 that leads to the molding unit 50. Within the intermediate melt reservoir 46 is a plunger 47, which is moved back and forth to expand the volume in the reservoir 46 to convey the melt to the molding unit 50. The plunger 47 within the intermediate melt reservoir 46 regulates flow of melt between the reservoir 46 and a melt chamber 52 of the injection device 54. Between the intermediate melt reservoir 46 and the melt chamber 52 of the injection device 54 is a shut-off valve 49 positioned within the second heated and temperature controlled melt pipe 42. The injection device 54 includes an injection cylinder 56 and an injection ram 58 reciprocating in the injection cylinder 56, whereby the melt chamber 52 is provided in the forward portion of the injection cylinder 56, anteriorly of the injection ram 58. Reciprocation of the injection ram 58 is implemented by a drive mechanism, generally designated by reference numeral 60 so that the ram 58 can be actively pushed forward or pulled backwards. The drive mechanism 60 may be realized in the form of an electric, pneumatic, or a hydraulic system.

The in-line compounding and molding process of FIG. 5 operates in the following manner. The screws of the twin screw extruder 20 are continuously driven by the drive motor 22, whereby the atactic polystyrene based resin 10, organic fiber 14, and inorganic filler 12 are continuously fed to the extruder hopper 18 as described above. The twin screw extruder 20 mixes the starting materials to produce a melt which is discharged through outlet 29 in the form of a continuous stream which is directed through conduits or melt pipes 42, 48 to the injection device 50. The injection device 50 operates essentially in two cycles, namely a filling phase and an injection phase. In the injection phase, the shutoff valve 49 is closed to prevent melt pressure building up in the injection device 50 from acting in the direction of the intermediate melt reservoir 46, and to allow injection of melt into an injection mold (not shown) via a shutoff valve 62, which is open. After conclusion of the injection phase, shutoff valve 62 is closed and shutoff valve 49 is opened to initiate the filling phase in which the injection ram 58 moves backwards as the melt chamber 52 of the injection device 60 is filled again via conduit or melt pipe 48 with melt. Melt produced by the twin screw extruder 20 is temporarily stored in the melt reservoir 46 during the injection procedure, whereby the plunger 47 is moved back to expand the volume in the melt reservoir 46.

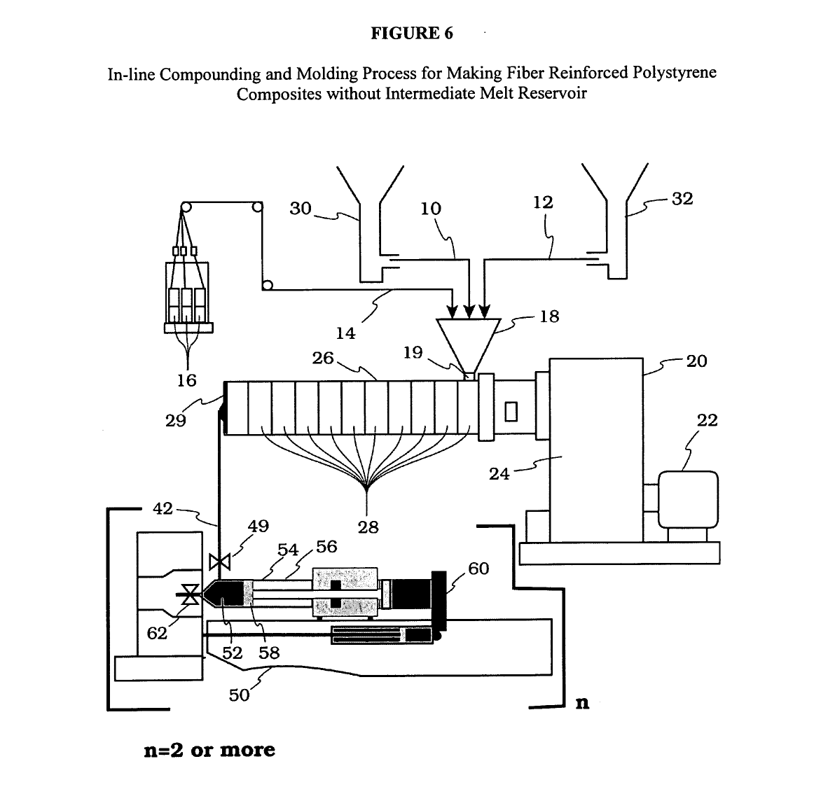

FIG. 6 depicts an alternative exemplary schematic of the in-line process for making fiber reinforced polystyrene composites of the present invention. The process of FIG. 6 is similar to FIG. 5, except for the hardware between the twin screw extruder 20 and the injection device 50. Parts corresponding with those in FIG. 5 are denoted by identical reference numerals and may not be explained again. Atactic polystyrene based resin 10, inorganic filler 12, and organic fiber 14 continuously unwound from one or more spools 16 are fed into an extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the polystyrene based resin 10 and the inorganic filler 12 prior to entering the feed throat 19 of the twin screw compounding extruder 20. In an alternative embodiment, as depicted in FIG. 2, the inorganic filler 12 may be fed to the twin screw compounding extruder 20 at a downstream feed port 27 in the extruder barrel 26 positioned downstream of the extruder hopper 18 while the atactic polystyrene based resin 10 and the organic fiber 14 are still metered into the extruder hopper 18.

The in-line compounding and molding machine of FIG. 6 includes a twin screw extruder 20 which is directly connected to the molding unit 50, without provision of an intermediate melt reservoir. The twin screw extruder 20 is coupled to the molding unit 50 via a heated and temperature controlled melt pipe 42. Also within the melt pipe 42 is a shutoff valve 49 for stopping melt flow between the twin screw extruder 20 and the melt reservoir 52 of the injection device 54. The injection device 54 again operates essentially in two cycles, namely a filling phase and an injection phase. When the molding machine 50 is in the filling phase and valve 49 in melt pipe 42 is open, a control unit (not shown), in response to a pressure deviation, instructs a control valve (not shown) to activate the drive mechanism 60 to move the injection ram 58 back to expand the volume of the melt chamber 52. As a consequence, the actual melt pressure is adjusted to the desired level. When the injection device 54 is in the injection phase, the shutoff valve 49 is closed to prevent melt pressure building up in the injection device 50 from acting in the direction of the twin screw extruder 20, and to allow injection of melt into an injection mold (not shown) via a shutoff valve 62, which is open. After conclusion of the injection phase, shutoff valve 62 is closed and shutoff valve 49 is opened to initiate the filling phase in which the injection ram 58 moves backwards as the melt chamber 52 of the injection device 54 is filled again via conduit or melt pipe 42 with melt. In this embodiment of the present invention, there are two or more molding units 50 (only 1 shown in FIG. 6) positioned at the end of the melt pipe 42 with each having an independent inlet shutoff valve 49. The two or more molding units are depicted as “n=2 or more” in FIG. 6. In this manner of operation, the melt continuously flowing from the twin screw extruder 20 fills one or more of the molding units 50 during the filling phase through shutoff valve 49 while another molding unit 50 is in the injection phase with the shutoff valve 49 leading to it in the closed position. Having two or more molding units 50 downstream of the twin screw extruder eliminates the need for an intermediate melt reservoir between the twin screw extruder 20 and the molding unit 50. The multiple (n=2 or more) molding units 50 of FIG. 5 are alternatively filled with melt continuously being provided by the twin screw extruder 20.

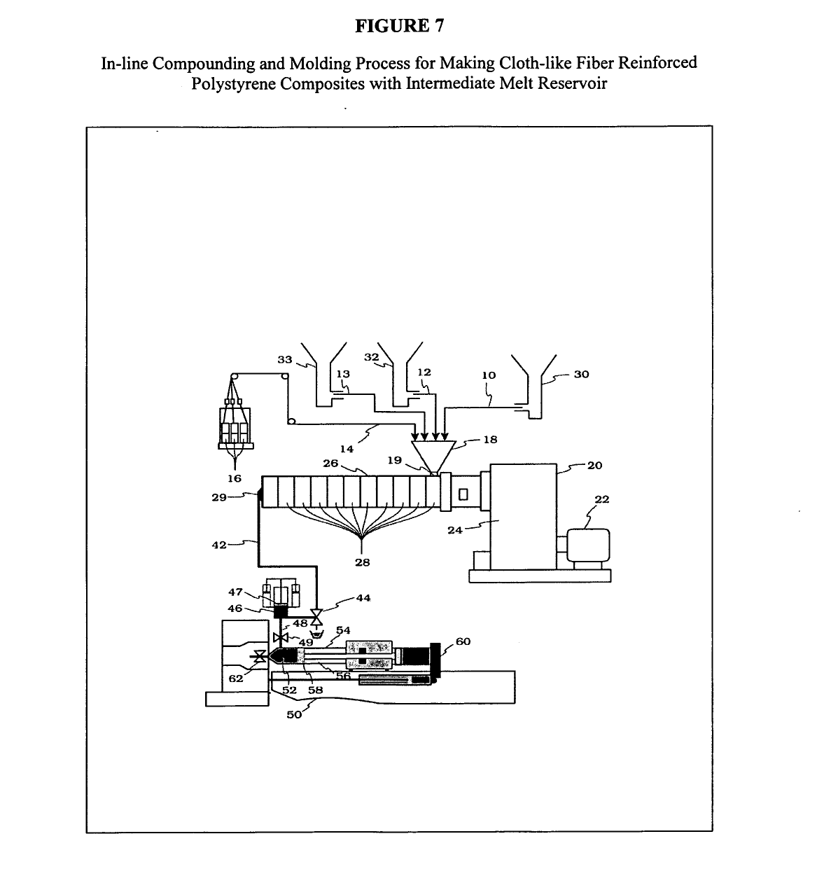

FIG. 7 depicts an exemplary schematic of the in-line compounding and molding process for making cloth-like fiber reinforced polystyrene composites of the instant invention. The process of FIG. 7 is similar to FIG. 5, except for the additional hardware needed to feed the colorant fiber 13 to the twin screw extruder 20. FIG. 7 includes an intermediate melt reservoir 46 between the twin screw extruder 20 and the molding unit 50. Parts corresponding with those in FIG. 5 are denoted by identical reference numerals and may not be explained again. Atactic polystyrene based resin 10, inorganic filler 12, colorant fiber 13, and organic reinforcing fiber 14 continuously unwound from one or more spools 16 are fed into the extruder hopper 18 of a twin screw compounding extruder 20. Colorant fiber 13 may be in the form of a masterbatch resin. The extruder hopper 18 is positioned above the feed throat 19 of the twin screw compounding extruder 20. The extruder hopper 18 may alternatively be provided with an auger (not shown) for mixing the atactic polystyrene based resin 10 and the inorganic filler 12 prior to entering the feed throat 19 of the twin screw compounding extruder 20. In an alternative embodiment, as depicted in FIG. 2, the inorganic filler 12 and/or the colorant fiber (not shown) may be fed to the twin screw compounding extruder 20 at a downstream feed port 27 in the extruder barrel 26 positioned downstream of the extruder hopper 18 while the atactic polystyrene based resin 10 and the organic reinforcing fiber 14 are still metered into the extruder hopper 18.

Referring to FIG. 7, the atactic polystyrene based resin 10 is metered to the extruder hopper 18 via a feed system 30 for accurately controlling the feed rate. Similarly, the inorganic filler 12 and colorant fiber 13 are metered to the extruder hopper 18 via feed systems 32, 33 for accurately controlling the feed rate. The feed systems 30, 32, 33 may be, but are not limited to, gravimetric feed system or volumetric feed systems. Gravimetric feed systems more accurately control the weight percentage of atactic polystyrene based resin 10, inorganic filler 12, and colorant fiber 13 being fed to the extruder hopper 18. The feed rate of organic reinforcing fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic reinforcing fiber 14 is fed to the twin screw compounding screw 20. The rate at which organic reinforcing fiber 14 is fed to the extruder hopper also increases with the greater the number of filaments within the organic reinforcing fiber 14 being unwound from a single fiber spool 16, the greater filament thickness, the greater the number fiber spools 16 being unwound simultaneously, and the rotations per minute of the extruder.

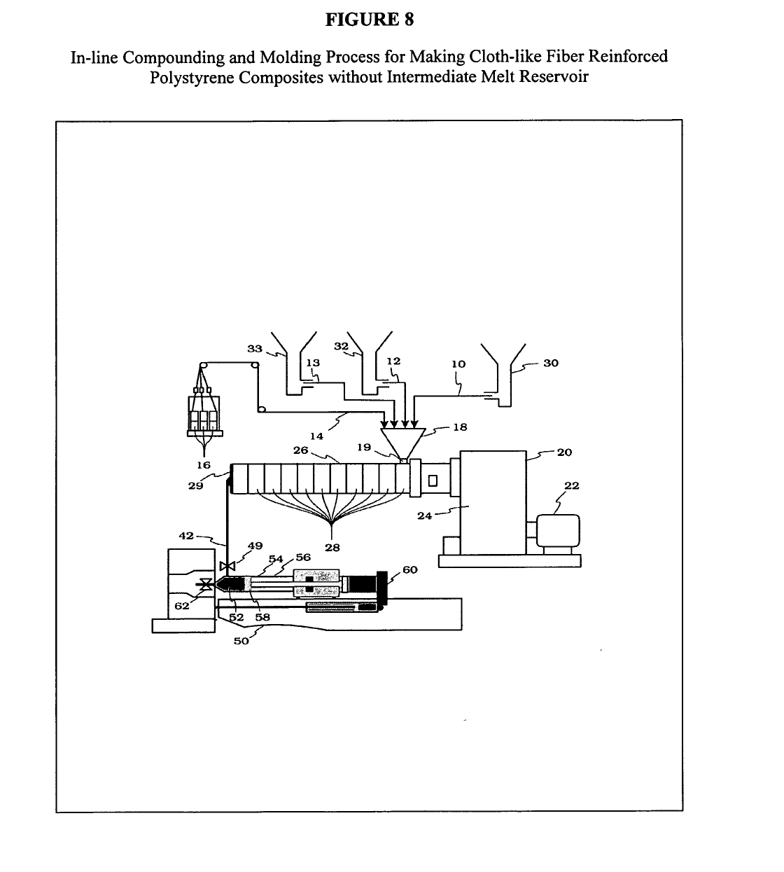

FIG. 8 depicts another exemplary schematic of the in-line compounding and molding process for making cloth-like fiber reinforced polystyrene composites of the instant invention. The process of FIG. 8 is similar to FIG. 6, except for additional hardware needed to feed the colorant fiber 13 to the twin screw extruder 20. The in-line compounding and molding machine of FIG. 8 includes a twin screw extruder 20 which is directly connected to the molding unit 50, without provision of an intermediate melt reservoir. Parts corresponding with those in FIG. 6 are denoted by identical reference numerals and may not be explained again. The feed throat 19 allows for the introduction of atactic polystyrene based resin 10, organic reinforcing fiber 14, colorant fiber 13, and inorganic filler 12 into a feed zone of the twin screw compounding extruder 20. The inorganic filler 12 and colorant fiber (not shown) may be optionally fed to the extruder 20 at the downstream feed port 27 depicted in FIG. 2. The twin screw configuration 30 for use in the twin screw extruders of the in-line compounding and molding processes of FIGS. 5, 6, 7, and 8 is similar to that as depicted and described in FIG. 3.

The process of continuously feeding organic reinforcing fiber into the hopper of the compounding extruder for making fiber reinforced polystyrene compositions of the present invention include, but are not limited to, one of more of the following advantages: the ability to continuously and accurately feed organic fiber into a compounding extruder, more uniform dispersion of the organic fiber in the resin pellets, and improved mechanical properties imparted by the more disperse organic fiber in the resins pellets.

The in-line compounding and molding process for making fiber reinforced polystyrene compositions of the present invention include, but are not limited to, one of more of the following advantages: reduced production costs and reduced raw material costs, higher material and part quality, shorter molding cycle times, improved flexibility in part formulations, improved retention of fiber properties after processing, and improved temperature control for permitting reduced clamping forces during molding.

The following examples illustrate the present invention and the advantages thereto without limiting the scope thereof.

### Test Methods

Fiber reinforced polystyrene compositions described herein were injection molded at 2300 psi pressure, 401° C. at all heating zones as well as the nozzle, with a mold temperature of 60° C.

Flexural modulus data was generated for injected molded samples produced from the fiber reinforced polystyrene compositions described herein using the ISO 178 standard procedure.

Instrumented impact test data was generated for injected mold samples produced from the fiber reinforced polystyrene compositions described herein using ASTM D3763. Ductility during instrumented impact testing (test conditions of 15 mph, −29° C., 25 lbs) is defined as no splintering of the sample.

### EXAMPLES

SC208 is an atactic polystyrene homopolymer available from Supreme Petrochemical Limited. The melt flow rate (MFR) of the polystyrene was 20 grams per 10 min measured at 200° C. according to ASTM D1238.

V3837 is a high aspect ratio talc available from Luzenac America Inc. of Englewood, Colo.

One-quarter inch long PET fiber cut from a multifilament yarn available from Invista Corporation.

### Illustrative Example 1

Various mixtures of one-quarter inch long PET fiber cut from filament were mixed with SC208 atactic polystyrene (PS) homopolymer and V3837 talc. The mixing took place in a Haake single screw extruder, with mixing taking place at a temperature of 175° C. The strand that exited the extruder was cut into one half inch lengths, and subsequently injection molded using a Boy 50M ton injection molder at 205° C. into a mold held at 60° C. Injection pressures and nozzle pressures were all maintained at 2300 psi. Samples were molded in accordance with the geometry of ASTM D3763 and tested for mechanical and physical properties in comparison with a 100% atactic PS control sample. More particularly, samples were measured for instrumented impact under standard automotive conditions for interior parts (25 pounds at 15 miles per hour (MPH) at −29 C) and flexural modulus in accordance with ISO178. The results are shown in the table below.

TABLE 1

| | | | | | | Flexural |
|---|---|---|---|---|---|---|
| | wt % | wt % | | Total | Instrumented | modulus |
| | poly- | PET | wt % | Energy | Impact Test | (psi |
| Example # | styrene | Fiber | talc | (ft-lbf) | Results | chord) |
| 1 | 44 | 15 | 41 | 5.2 | ductile* | 1,540,000 |
| 2 | 67.5 | 12.5 | 20 | 4.6 | ductile/brittle** | 799,000 |
| 3 | 100 | 0 | 0 | <1 | brittle*** | — |

*Examples 1: samples did not shatter or split as a result of impact, with no pieces coming off of the specimen.
**Example 2: pieces broke off of the sample as a result of the impact.
***Example 3: samples completely shattered as a result of impact.

More significant than the energy to maximum load, the samples containing fiber loadings of 15 wt % did not shatter or split as a result of the impact, with no pieces coming off the specimen. At a 12.5 wt % fiber loading and lower talc composition, the samples still did not shatter, but displayed a mixed mode of both ductile and brittle behavior, with one piece of the instrumented impact samples breaking off the sample. In contrast, the polystyrene control sample shattered catastrophically under the same conditions of impact.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A process for making a fiber reinforced polystyrene article comprising:
(a) at least 30 wt %, based on the total weight of the composition, atactic polystyrene based polymer;
(b) from 5 to 50 wt %, based on the total weight of the composition, organic fiber; and
(c) from 0 to 60 wt %, based on the total weight of the composition, inorganic filler;
wherein said article molded from said composition has a flexural modulus of at least 350,000 psi and exhibits ductility during instrumented impact testing,
wherein the process comprises:
(a) extrusion compounding the composition to form an extrudate, and
(b) molding said extrudate to form said article.

2. The process of claim 1 wherein said organic fiber is cut prior to said extrusion compounding step.

3. The process of claim 1 wherein during said extrusion compounding step, said organic fiber is a continuous fiber and is fed directly from one or more spools into an extruder hopper.

4. The process of claim 1 wherein said extrusion compounding step comprises a single screw compounding extruder or a twin screw compounding extruder.

5. The process of claim 1 wherein said molding step is chosen from injection molding, blow molding, rotational molding, thermoforming, compression molding, and compression/injection molding.

6. The process of claim 1 wherein said atactic polystyrene based polymer is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene, and combinations thereof.

7. The process of claim 6 wherein said atactic polystyrene based polymer is produced from styrene.

8. The process of claim 1 wherein said organic fiber is chosen from polyalkylene terephthalates, polyalkylene naphthalates, polyamides, polyolefins, polyacrylonitrile, and combinations thereof.

9. The process of claim 8 wherein said organic fiber is polyethylene terephthalate.

10. The process of claim 1 wherein said inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

11. The process of claim 10 wherein said inorganic filler is talc or wollastonite.

12. The process of claim 1 wherein said article further comprises from 0.01 to 0.2 wt %, based on the total weight of the composition, lubricant.

13. The process of claim 12 wherein said lubricant is chosen from silicon oil, silicon gum, fatty amide, paraffin oil, paraffin wax, ester oil, and combinations thereof.

14. The process of claim 1 wherein said article further comprises from 0.1 to 2.5 wt %, based on the total weight of the composition, colorant fiber, and said article further exhibits a cloth-like appearance.

15. The process of claim 14 wherein said colorant fiber includes an inorganic pigment, an organic dye, or a combination thereof.

16. The process of claim 15 wherein said colorant fiber is chosen from cellulosic fiber, acrylic fiber, nylon type fiber, polyester type fiber, and combinations thereof.

17. The process of claim 1 wherein said article has a flexural modulus of at least 750,000 psi.

18. The process of claim 1 wherein said article has a flexural modulus of at least 1,500,000 psi.

19. The process of claim 1 wherein said article is an automotive part, a household appliance part, or a boat hull.

20. The process of claim 19 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.

21. A process for making fiber reinforced polystyrene composite resin comprising:
(a) feeding into a twin screw extruder hopper at least 35 wt % of an atactic polystyrene based resin,
(b) continuously feeding by unwinding from one or more spools into said twin screw extruder hopper from 10 wt % to 50 wt % of a polyester fiber,
(c) feeding into a twin screw extruder from 15 wt % to 45 wt % of talc,
(d) extruding said atactic polystyrene based resin, said polyester fiber, and said talc through said twin screw extruder to form a fiber reinforced polystyrene composite melt,
(e) cooling said fiber reinforced polystyrene composite melt to form a solid fiber reinforced polystyrene composite, and
(f) pelletizing said solid fiber reinforced polystyrene composite to form a fiber reinforced polystyrene composite resin.

22. The process of claim 21 wherein an article molded from said fiber reinforced polystyrene composite resin has a flexural modulus of at least 750,000 psi and exhibits ductility during instrumented impact testing.

23. The process of claim 21 wherein said atactic polystyrene based resin is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene, and combinations thereof.

24. The process of claim 23 wherein said atactic polystyrene based resin is produced from styrene.

25. The process of claim of claim 21 further comprising feeding from 0.01 to 0.1 wt % lubricant, wherein said lubricant is chosen from silicon oil, silicon gum, fatty amide, paraffin oil, paraffin wax, ester oil, and combinations thereof.

26. The process of claim 21 wherein feeding said talc into said twin screw extruder is via said twin screw extruder hopper with a gravimetric feed system or via a downstream injection port with a gravimetric feed system.

27. The process of claim 21 wherein said twin screw extruder comprises two extruder screws configured with interconnected screw elements to have a feed zone, a melting zone, one or more mixing sections, one or more decompression sections and one or more conveying sections.

28. The process of claim 27 wherein said two extruder screws are of a co-rotating intermeshing, counter-rotating intermeshing, or counter-rotating non-intermeshing screw type.

29. The process of claim 27 wherein said one or more mixing sections comprise one or more kneading blocks positioned along the length of said two extruder screws.

30. The process of claim 29 wherein said one or more kneading blocks comprise a series of interconnected kneading elements.

31. The process of claim 29 wherein said one or more mixing sections break up said polyester fiber into ⅛ inch to 1 inch fiber lengths.

32. The process of claim 21 wherein said twin screw extruder includes barrel temperature control zone set points of less than or equal to 175° C.

33. The process of claim 22 further comprising feeding into said twin screw extruder from 0.1 to 2.5 wt % colorant fiber, wherein said article exhibits a cloth-like appearance.

34. The process of claim 33 wherein said colorant fiber includes an inorganic pigment, an organic dye, or a combination thereof.

35. The process of claim 34 wherein said colorant fiber is chosen from cellulosic fiber, acrylic fiber, nylon type fiber, polyester type fiber, and combinations thereof.

36. The process of claim 22 wherein said article has a flexural modulus of at least 1,500,000 psi.

37. The process of claim 22 wherein said article is an automotive part, a household appliance part, or a boat hull.

38. The process of claim 37 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.

39. A process for making a fiber reinforced polystyrene article comprising:
(a) providing an in-line compounding and molding machine comprising an extrusion compounding machine fluidly coupled to a molding machine;
(b) extrusion compounding in said extrusion compounding machine a composition comprising:
(i) at least 30 wt %, based on the total weight of the composition, atactic polystyrene based polymer;
(ii) from 5 to 50 wt %, based on the total weight of the composition, organic fiber; and
(iii) from 0 to 60 wt %, based on the total weight of the composition, inorganic filler; to form a melt extrudate;
(c) conveying said melt extrudate to said molding machine; and
(d) molding said melt extrudate in said molding machine to form an article having a flexural modulus of at least 350,000 psi and exhibiting ductility during instrumented impact testing.

40. The process of claim 39, wherein said in-line compounding and molding machine further comprises an intermediate melt reservoir between said extrusion compounding machine and said molding machine.

41. The process of claim 39 wherein said extrusion compounding machine is a single screw compounding extruder or a twin screw compounding extruder.

42. The process of claim 39 wherein said molding machine is chosen from an injection molder, a blow molder, a rotational molder, a thermoformer, a compression molder, and a compression/injection molder.

43. The process of claim 42 wherein said injection molder comprises two or more injection devices which are alternatively filled with said melt extrudate from said extrusion compounding machine.

44. The process of claim 39 wherein said organic fiber is cut prior to said extrusion compounding step.

45. The process of claim 39 wherein during said extrusion compounding step, said organic fiber is a continuous fiber and is fed directly from one or more spools into an extruder hopper of said extrusion compounding machine.

46. The process of claim of claim 39 further comprising extrusion compounding from 0.01 to 0.1 wt % lubricant, based on the total weight of the composition.

47. The process of claim 39 further comprising extrusion compounding from 0.1 to 2.5 wt % colorant fiber, based on the total weight of the composition, wherein said article further exhibits a cloth-like appearance.

48. The process of claim 39 wherein said article has a flexural modulus of at least 750,000 psi.

49. The process of claim 39 wherein said article is an automotive part, a household appliance part, or a boat hull.

50. The process of claim 49 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.

51. A process for making a fiber reinforced polystyrene article comprising:
(a) providing an in-line compounding and molding machine comprising a twin screw extruder fluidly coupled to an injection molder,
(b) feeding into said twin screw extruder hopper at least 30 wt % of an atactic polystyrene based resin,
(c) continuously feeding by unwinding from one or more spools into said twin screw extruder hopper from 5 wt % to 50 wt % of an organic fiber,
(d) feeding into said twin screw extruder from 0 wt % to 60 wt % of an inorganic filler,
(e) extruding said atactic polystyrene based resin, said organic fiber, and said inorganic filler through said twin screw extruder to form a fiber reinforced polystyrene melt,
(f) conveying said fiber reinforced polystyrene melt to said injection molder, and
(g) molding said fiber reinforced polystyrene melt to form a fiber reinforced polystyrene article.

52. The process of claim 51 wherein said article has a flexural modulus of at least 350,000 psi and exhibits ductility during instrumented impact testing.

53. The process of claim 51 wherein said in-line compounding and molding machine further comprises an intermediate melt reservoir between said twin screw extruder and said injection molder.

54. The process of claim 51 wherein said injection molder comprises two or more injection devices which are alternatively filled with said fiber reinforced polystyrene melt from said twin screw extruder.

55. The process of claim 51 wherein said atactic polystyrene based resin is produced from a monomer chosen from styrene, α-methylstyrene, methylstyrene, ethylstyrene, isopropylstyrene, tertiary butylstyrene, phenylstyrene, vinylstyrene, chlorostyrene, bromostyrene, fluorostyrene, chloromethylstyrene, methoxystyrene, ethoxystyrene, and combinations thereof.

56. The process of claim 55 wherein said atactic polystyrene based resin is produced from styrene.

57. The process of claim 51 wherein said organic fiber is chosen from polyalkylene terephthalates, polyalkylene naphthalates, polyamides, polyolefins, polyacrylonitrile, and combinations thereof.

58. The process of claim 57 wherein said organic fiber is polyethylene terephthalate.

59. The process of claim 51 wherein said inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

60. The process of claim 59 wherein said inorganic filler is talc or wollastonite.

61. The process of claim of claim 51 further comprising feeding from 0.01 to 0.1 wt % lubricant into said twin extruder, wherein said lubricant is chosen from silicon oil, silicon gum, fatty amide, paraffin oil, paraffin wax, ester oil, and combinations thereof.

62. The process of claim 52 further comprising feeding from 0.1 to 2.5 wt % colorant fiber into said twin screw extruder, and wherein said article further exhibits a cloth-like appearance.

63. The process of claim 62 wherein said colorant fiber includes an inorganic pigment, an organic dye, or a combination thereof.

64. The process of claim 63 wherein said colorant fiber is chosen from cellulosic fiber, acrylic fiber, nylon type fiber, polyester type fiber, and combinations thereof.

65. The process of claim 51 wherein feeding said inorganic filler into said twin screw extruder is via said twin screw extruder hopper with a gravimetric feed system or via a downstream injection port with a gravimetric feed system.

66. The process of claim 51 wherein said twin screw extruder comprises two extruder screws configured with interconnected screw elements to have a feed zone, a melting zone, one or more mixing sections, one or more decompression sections and one or more conveying sections.

67. The process of claim 66 wherein said two extruder screws are of a co-rotating intermeshing, counter-rotating intermeshing, or counter-rotating non-intermeshing screw type.

68. The process of claim 66 wherein said one or more mixing sections comprise one or more kneading blocks positioned along the length of said two extruder screws.

69. The process of claim 68 wherein said one or more kneading blocks comprise a series of interconnected kneading elements.

70. The process of claim 68 wherein said one or more mixing sections break up said organic fiber into ⅛ inch to 1 inch fiber lengths.

71. The process of claim 51 wherein said twin screw extruder includes barrel temperature control zone set points of less than or equal to 175° C.

72. The process of claim 52 wherein said article has a flexural modulus of at least 750,000 psi.

73. The process of claim 72 wherein said article has a flexural modulus of at least 1,500,000 psi.

74. The process of claim 52 wherein said article is an automotive part, a household appliance part, or a boat hull.

75. The process of claim 74 wherein said automotive part is chosen from bumpers, aesthetic trim parts, body panels, under body parts, under hood parts, door cores, steering wheel covers, head liner panels, dashboard panels, interior door trim panels, package trays, seat backs, pillar trim cover panels, and under-dashboard panels.
